(19) United States
(12) Patent Application Publication
(10) Pub. No.: US 2024/0250743 A1
(43) Pub. Date: Jul. 25, 2024

(54) ENERGY-EFFICIENT INFORMATION TRANSFER VIA RECONFIGURABLE INTELLIGENT SURFACE PARTITIONING

(71) Applicant: QUALCOMM Incorporated, San Diego, CA (US)

(72) Inventors: Yavuz YAPICI, Florham Park, NJ (US); Narayan PRASAD, Westfield, NJ (US); Tao LUO, San Diego, CA (US); Junyi LI, Fairless Hills, PA (US)

(21) Appl. No.: 18/158,603

(22) Filed: Jan. 24, 2023

(51) Int. Cl. H04B 7/145

(52) U.S. Cl. CPC H04B 7/145

(57) ABSTRACT

Various aspects of the present disclosure generally relate to wireless communication. In some aspects, a reconfigurable intelligent surface (RIS) may receive configuration information indicating a passive beamforming and information transfer (PBIT) scheme, the configuration information being based at least in part on at least one of energy consumption of the PBIT scheme or an error performance of the PBIT scheme. The RIS may communicate information available to the RIS to the network device based at least in part on the PBIT scheme. Numerous other aspects are described.

### FIELD OF THE DISCLOSURE

Aspects of the present disclosure generally relate to wireless communication and to techniques and apparatuses for energy-efficient information transfer via reconfigurable intelligent surface partitioning.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a reconfigurable intelligent surface (RIS). The method may include receiving configuration information indicating a passive beamforming and information transfer (PBIT) scheme, the configuration information being based at least in part on at least one of energy consumption of the PBIT scheme or an error performance of the PBIT scheme. The method may include communicating information available to the RIS to the network device based at least in part on the PBIT scheme.

Some aspects described herein relate to a method of wireless communication performed by a network node. The method may include selecting a PBIT scheme that is to be used by an RIS to communicate information available to the RIS to a network device based at least in part on at least one of energy consumption of the PBIT scheme or an error performance of the PBIT scheme. The method may include transmitting, to the RIS, configuration information indicating the PBIT scheme.

Some aspects described herein relate to an RIS for wireless communication. The RIS may include a memory and one or more processors coupled to the memory. The one or more processors may be configured to receive configuration information indicating a PBIT scheme, the configuration information being based at least in part on at least one of energy consumption of the PBIT scheme or an error performance of the PBIT scheme. The one or more processors may be configured to communicate information available to the RIS to the network device based at least in part on the PBIT scheme.

Some aspects described herein relate to a network node for wireless communication. The network node may include a memory and one or more processors coupled to the memory. The one or more processors may be configured to select a PBIT scheme that is to be used by an RIS to communicate information available to the RIS to a network device based at least in part on at least one of energy consumption of the PBIT scheme or an error performance of the PBIT scheme. The one or more processors may be configured to transmit, to the RIS, configuration information indicating the PBIT scheme.

Some aspects described herein relate to a non-transitory computer-readable medium that stores one or more instructions for wireless communication by an RIS. The one or more instructions, when executed by one or more processors of the RIS, may cause the RIS to receive configuration information indicating a PBIT scheme, the configuration information being based at least in part on at least one of energy consumption of the PBIT scheme or an error performance of the PBIT scheme. The one or more instructions, when executed by one or more processors of the RIS, may cause the RIS to communicate information available to the RIS to the network device based at least in part on the PBIT scheme.

Some aspects described herein relate to a non-transitory computer-readable medium that stores one or more instructions for wireless communication by a network node. The one or more instructions, when executed by one or more processors of the network node, may cause the network node to select a PBIT scheme that is to be used by an RIS to communicate information available to the RIS to a network device based at least in part on at least one of energy consumption of the PBIT scheme or an error performance of the PBIT scheme. The one or more instructions, when executed by one or more processors of the network node, may cause the network node to transmit, to the RIS, configuration information indicating the PBIT scheme.

Some aspects described herein relate to an apparatus for wireless communication. The apparatus may include means for receiving configuration information indicating a PBIT scheme, the configuration information being based at least in part on at least one of energy consumption of the PBIT scheme or an error performance of the PBIT scheme. The apparatus may include means for communicating information available to the RIS to the network device based at least in part on the PBIT scheme.

Some aspects described herein relate to an apparatus for wireless communication. The apparatus may include means for selecting a PBIT scheme that is to be used by an RIS to communicate information available to the RIS to a network device based at least in part on at least one of energy consumption of the PBIT scheme or an error performance of the PBIT scheme. The apparatus may include means for transmitting, to the RIS, configuration information indicating the PBIT scheme.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of communications using a reconfigurable intelligent surface (RIS), in accordance with the present disclosure.

FIG. 5 is a diagram illustrating an example of communication links in a wireless network that includes an RIS, in accordance with the present disclosure.

FIGS. 6A-6D are diagrams illustrating an example of energy-efficient information transfer via RIS partitioning, in accordance with the present disclosure.

FIG. 7 is a diagram of an example associated with energy-efficient information transfer via RIS partitioning, in accordance with the present disclosure.

FIG. 8 is a diagram illustrating an example process performed, for example, by an RIS, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

In some cases, a network node may communicate with a user equipment (UE) by reflecting a signal off of an intermediary entity, such as a reconfigurable intelligent surface (RIS). The RIS may be associated with an RIS controller that receives control signals from the network node or a similar entity and thus is able to reconfigure itself to improve a communication link between the network node and the UE, such as by powering on and/or moving reflective elements associated with the RIS. In some cases, the RIS controller may not be capable of directly transmitting a communication to a network entity (e.g., a modem of the RIS controller may not have transmit capabilities) or else may be configured to transmit communications infrequently and/or under a limited power budget. This may make it difficult to effectively incorporate RISs into a wireless network (e.g., a cellular framework) due to the RIS's lack of ability to share its own data (e.g., control data) with other network entities.

In some examples, the RIS may thus utilize passive beamforming and information transfer (PBIT) to communicate with other network entities (e.g., network nodes, UEs, and/or other RISs), such as to share RIS data (e.g., control data) with other network entities. In PBIT, a signal transmitted by a network node or another network entity is selectively reflected off of a reflective surface of the RIS in order to modulate information bits into the reflected signal. In some cases, PBIT schemes implemented by an RIS may result in high communication errors at the UE, requiring high retransmission rates and/or other resource expenditure to correct the communication errors. In order to reduce communication errors, an RIS may employ a high-power-consuming PBIT scheme to increase beamforming gain or otherwise improve a communication link between the RIS and the UE, which may result in unnecessary energy expenditure at the RIS for low quality-of-service (QoS) applications and/or applications that can otherwise tolerate relatively high communication errors.

Some techniques and apparatuses described herein enable energy-efficient PBIT schemes for communication by an RIS. In some aspects, a network may select one of multiple PBIT schemes to be used by an RIS based at least in part on energy consumption of the selected PBIT scheme and/or an error performance of the selected PBIT scheme. For example, for high QoS applications and/or applications requiring a low error rate, the network may select a PBIT scheme exhibiting good error performance, sometimes at the expense of requiring high power consumption. In other applications, such as low QoS applications and/or applications in which a relatively high error rate is acceptable, the network may select a PBIT scheme exhibiting low power consumption. In some aspects, the network node may select a PBIT scheme associated with virtual partitions and/or all-zero-free on-off keying (OOK) in order to improve an error performance associated with the PBIT scheme. As a result, the techniques and apparatuses described herein may improve communication performance and energy efficiency by enabling flexible selection of an appropriate PBIT scheme for a given RIS application.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

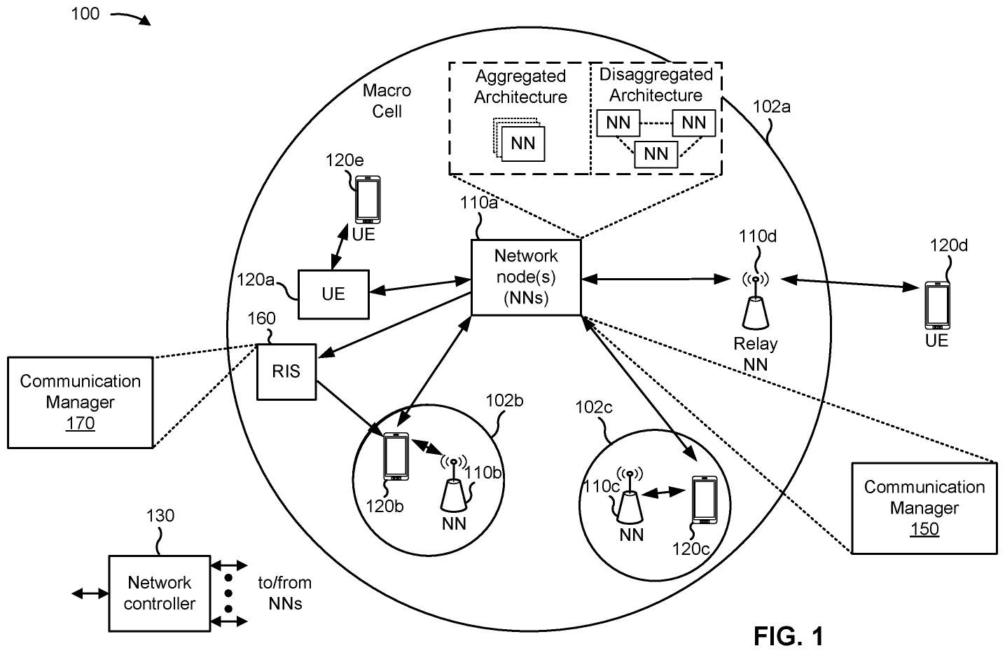

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

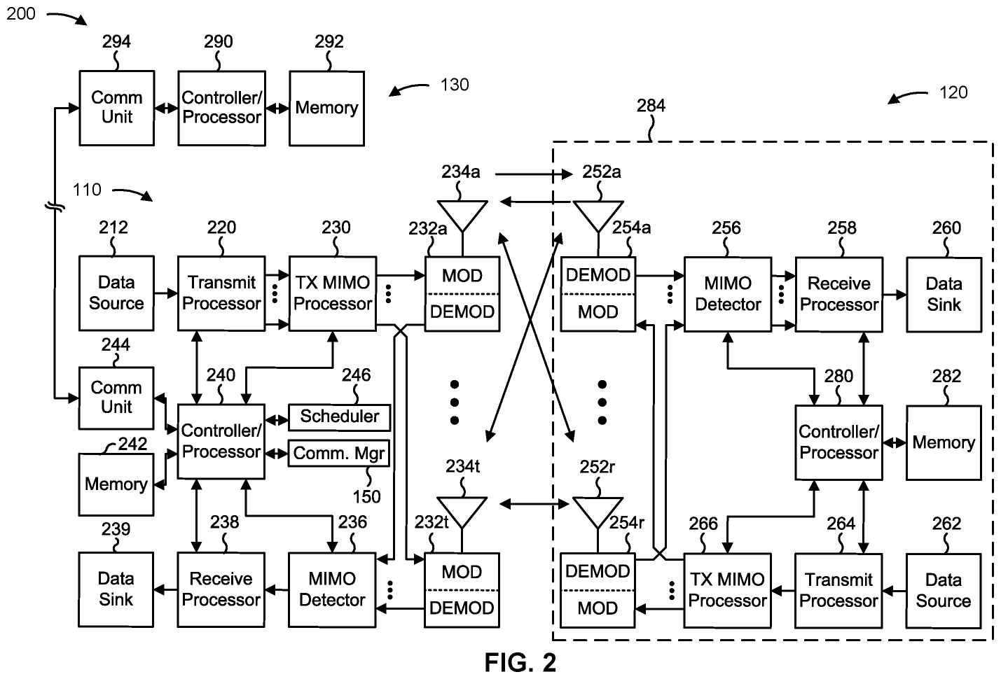

In some aspects, the wireless network 100 may include an RIS 160. In some aspects, the RIS 160 may correspond to a UE 120 and/or may include components associated with the UE 120, such as a modem similar to the modem 254 of the UE 120 described below in connection with FIG. 2. In some aspects, the RIS 160 may include a communication manager 170. As described in more detail elsewhere herein, the communication manager 170 may receive configuration information indicating a PBIT scheme, the configuration information being based at least in part on at least one of energy consumption of the PBIT scheme or an error performance of the PBIT scheme; and communicate information available to the RIS to the network device based at least in part on the PBIT scheme. Additionally, or alternatively, the communication manager 170 may perform one or more other operations described herein.

In some aspects, the network node 110 may include a communication manager 150. As described in more detail elsewhere herein, the communication manager 150 may select a PBIT scheme that is to be used by an RIS to communicate information available to the RIS to a network device based at least in part on at least one of energy consumption of the PBIT scheme or an error performance of the PBIT scheme; and transmit, to the RIS, configuration information indicating the PBIT scheme. Additionally, or alternatively, the communication manager 150 may perform one or more other operations described herein.

As indicated above, FIG. 1 is provided as an example. Other examples may differ from what is described with regard to FIG. 1.

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

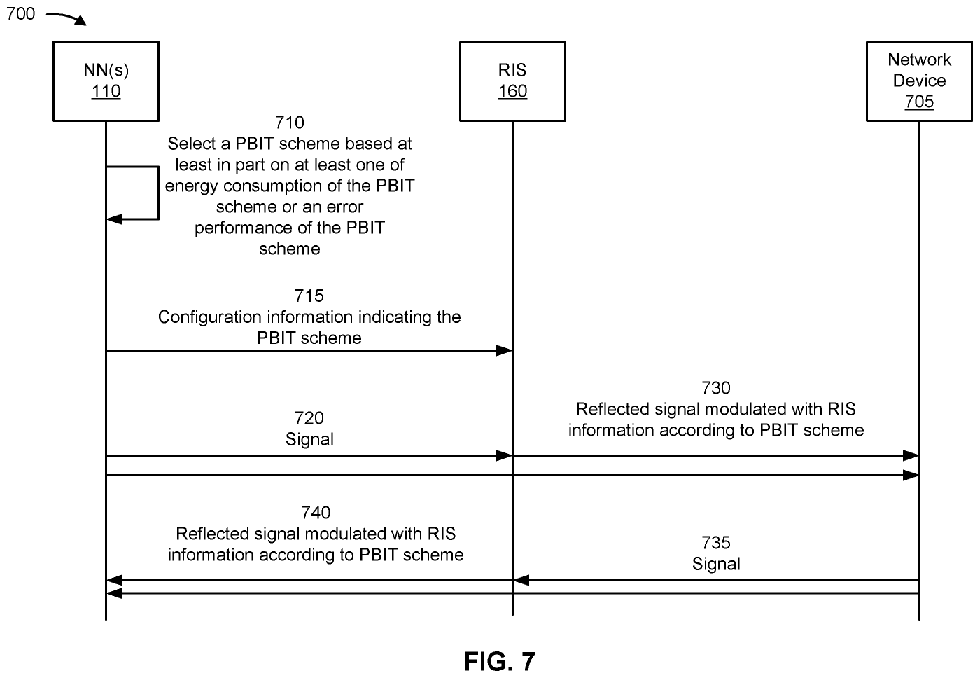

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

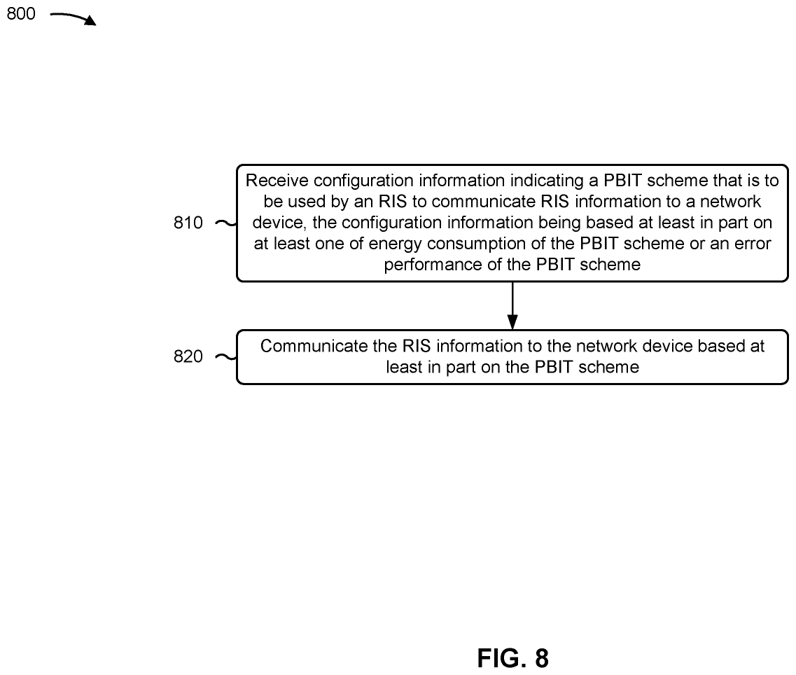

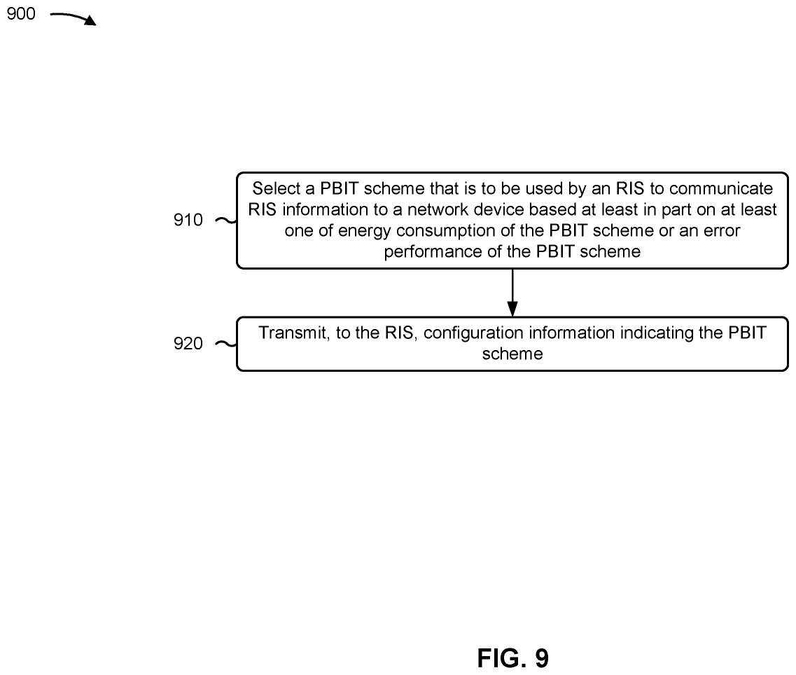

The controller/processor 240 of the network node 110, the controller/processor 280 of the UE 120, and/or any other component(s) of FIG. 2 may perform one or more techniques associated with energy-efficient information transfer via RIS partitioning, as described in more detail elsewhere herein. In some aspects, the RIS 160 described herein is the UE 120, is included in the UE 120, or includes one or more components of the UE 120 shown in FIG. 2. The controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, an RIS (e.g., the RIS 160) includes means for receiving configuration information indicating a PBIT scheme, the configuration information being based at least in part on at least one of energy consumption of the PBIT scheme or an error performance of the PBIT scheme; and/or means for communicating information available to the RIS to the network device based at least in part on the PBIT scheme. In some aspects, the means for the RIS to perform operations described herein may include, for example, one or more of communication manager 170, antenna 252, modem 254, MIMO detector 256, receive processor 258, transmit processor 264, TX MIMO processor 266, controller/processor 280, or memory 282.

In some aspects, a network node (e.g., the network node 110) includes means for selecting a PBIT scheme that is to be used by a RIS to communicate information available to the RIS to a network device based at least in part on at least one of energy consumption of the PBIT scheme or an error performance of the PBIT scheme; and/or means for transmitting, to the RIS, configuration information indicating the PBIT scheme. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

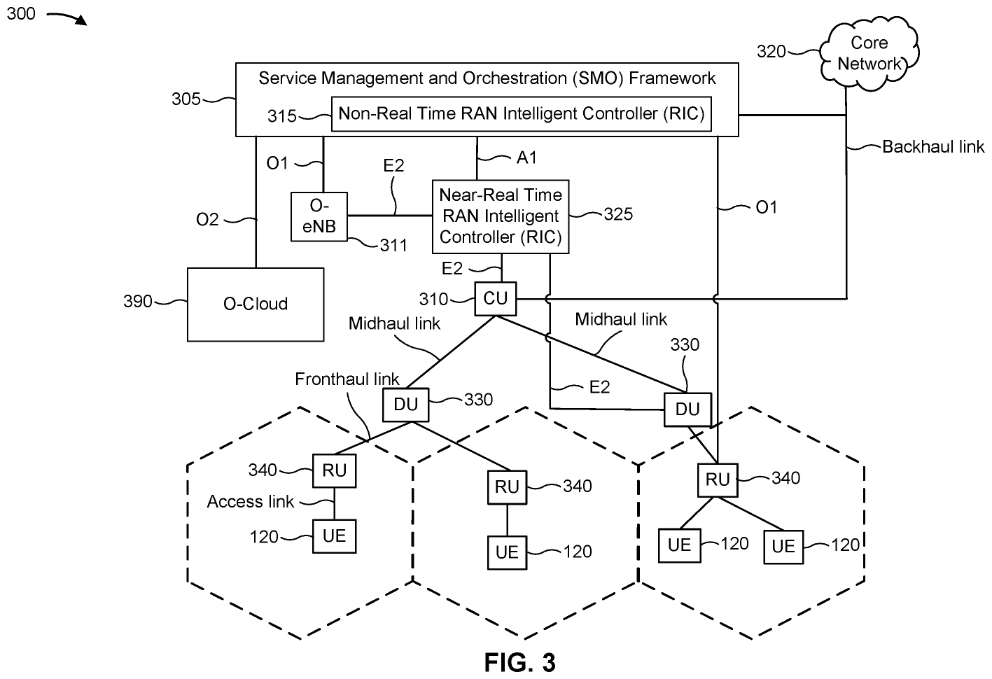

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

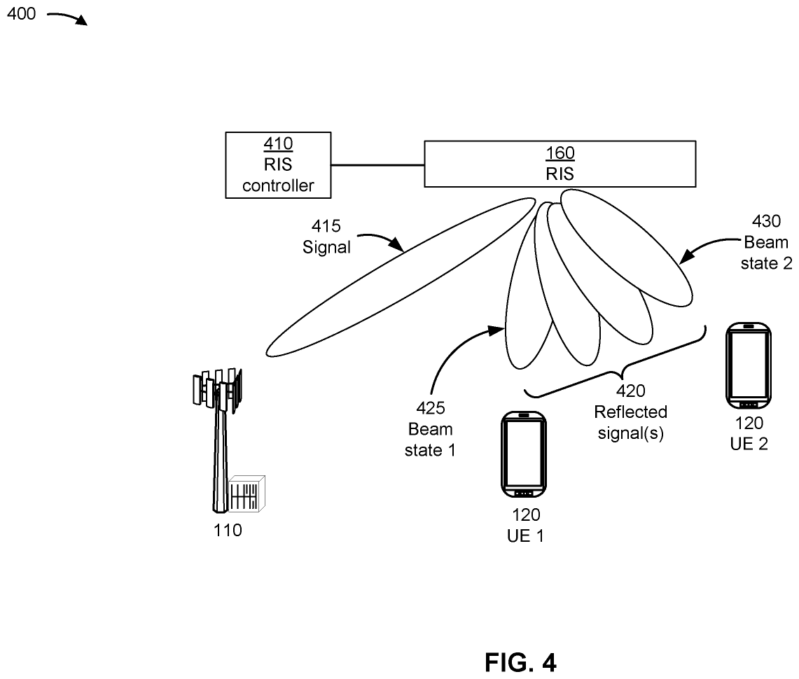

FIG. 4 is a diagram illustrating an example 400 of communications using an RIS, in accordance with the present disclosure. As shown in FIG. 4, a network node 110 may communicate with a UE 120 in a wireless network, such as the wireless network 100. The network node 110 and the UE 120 may use the RIS 160 to communicate with one another. For example, the RIS 160 may reflect or redirect a signal to the network node 110 and/or the UE 120. The RIS 160 may also be referred to as an intelligent reflecting surface. In some examples, the RIS 160 may be a repeater.

The RIS 160 may be, or may include, a planar or two-dimensional structure or surface that is designed to have properties to enable a dynamic control of signals or electromagnetic waves reflected and/or redirected by the RIS 160. The RIS 160 may include one or more reconfigurable elements. For example, the RIS 160 may include an array of reconfigurable elements (e.g., an array of uniformly distributed reconfigurable elements). The reconfigurable elements may be elements with a reconfigurable electromagnetic characteristic. For example, the electromagnetic characteristic may include a reflection characteristic (e.g., a reflection coefficient), a scattering characteristic, an absorption characteristic, and/or a diffraction characteristic. The electromagnetic characteristic(s) of each reconfigurable element may be independently controlled and changed over time. The electromagnetic characteristic(s) of each reconfigurable element may be independently configured such that the combination of configured states of the reconfigurable elements reflects an incident signal or waveform in a controlled manner. For example, the reconfigurable elements may be configured to reflect or redirect an impinging signal in a controlled manner, such as by reflecting the impinging signal in a desired direction, with a desired beam width, with a desired phase, with a desired amplitude, and/or with a desired polarization, among other examples. In other words, the RIS 160 may be capable of modifying one or more properties (e.g., direction, beam width, phase, amplitude, and/or polarization) of an impinging signal.

The reconfigurable elements of the RIS 160 may be controlled and/or configured by an RIS controller 410. The RIS controller 410 may be a control module (e.g., a controller and/or a processor) that is capable of configuring the electromagnetic characteristic(s) of each reconfigurable element of the RIS 160. The RIS controller 410 may be, or may be included in, the communication manager 170. Alternatively, the communication manager 170 may be included in the RIS controller 410. The RIS controller 410 may be associated with certain components similar to the components described in connection with the UE 120 in connection with FIG. 2, such as a modem 254 and/or a similar component for purposes of communicating with a network node 110. The RIS controller 410 may receive control communications (e.g., from a network node 110 and/or a UE 120) indicating one or more properties of reflected signals (e.g., indicating a desired direction, a desired beam width, a desired phase, a desired amplitude, and/or a desired polarization). Therefore, in some examples, the RIS 160 may be capable of receiving communications (e.g., via the RIS 160 and/or the RIS controller 410). In some examples, the RIS 160 and/or the RIS controller 410 may not have transmit capabilities (e.g., the RIS 160 may be capable of reflecting and/or redirecting impinging signals via the reconfigurable elements, but may not be capable of generating and/or transmitting signals). Alternatively, in some examples, the RIS 160 and/or the RIS controller 410 may have transmit capabilities (e.g., the RIS 160 may be capable of reflecting and/or redirecting impinging signals via the reconfigurable elements and may be capable of generating and/or transmitting signals). For example, the RIS 160 and/or the RIS controller 410 may include one or more antennas and/or antenna elements for receiving and/or transmitting signals.

For example, as shown in FIG. 4, the network node 110 may transmit a signal 415. The signal 415 may be transmitted in a spatial direction toward the RIS 160. The RIS 160 may configure the reconfigurable elements of the RIS 160 to reflect and/or redirect the signal 415 in a desired spatial direction and/or with one or more desired signal characteristics (e.g., beam width, phase, amplitude, frequency, and/or polarization). For example, as shown by reference number 420, the RIS 160 may be capable of reflecting the signal 415 in one or more spatial directions. Although multiple beams are shown in FIG. 4 representing different beam states or beam directions of the RIS 160, the RIS 160 may be capable of reflecting a signal with one beam state or one beam direction at a time. For example, in one case, as shown by reference number 425, the RIS 160 may be configured to reflect the signal 415 using a first beam state (e.g., beam state 1). “Beam state” may refer to a spatial direction and/or a beam of a reflected signal (e.g., a signal reflected by the RIS 160). The first beam state may cause the signal 415 to be reflected in a spatial direction toward a first UE 120 (e.g., UE 1). As shown by reference number 430, in another case, the RIS 160 may be configured to reflect the signal 415 using a second beam state (e.g., beam state 2). The second beam state may cause the signal 415 to be reflected in a spatial direction toward a second UE 120 (e.g., UE 2).

The RIS 160 may be deployed in a wireless network (such as the wireless network 100) to improve communication performance and efficiency. For example, the RIS 160 may enable a transmitter (e.g., a network node 110 or a UE 120) to control the scattering, reflection, and refraction characteristics of signals transmitted by the transmitter, to overcome the negative effects of wireless propagation. For example, the RIS 160 may effectively control signal characteristics (e.g., spatial direction, beam width, phase, amplitude, frequency, and/or polarization) of an impinging signal without a need for complex decoding, encoding, and radio frequency processing operations. Therefore, the RIS 160 may provide increased channel diversity for propagation of signals in a wireless network. The increased channel diversity provides robustness to channel fading and/or blocking, such as when higher frequencies are used by the network node 110 and/or the UE 120 (e.g., millimeter wave frequencies and/or sub-terahertz frequencies). Moreover, as the RIS 160 does not need to perform complex decoding, encoding, and radio frequency processing operations, the RIS 160 may provide a more cost and energy efficient manner of reflecting and/or redirecting signals in a wireless network (e.g., as compared to other mechanisms for reflecting and/or redirecting signals, such as a relay device).

As indicated above, FIG. 4 is provided as an example. Other examples may differ from what is described with respect to FIG. 4.

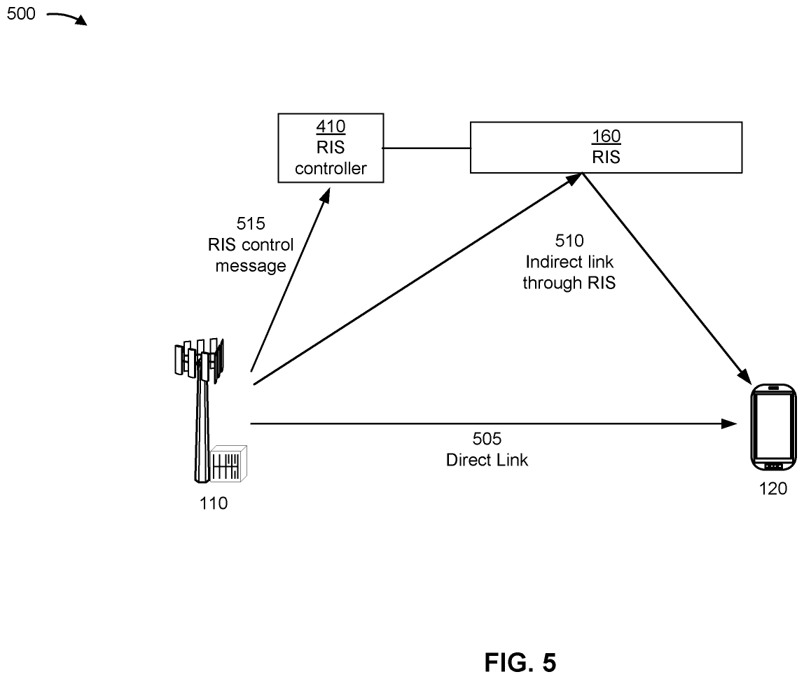

FIG. 5 is a diagram illustrating an example 500 of communication links in a wireless network that includes an RIS, in accordance with the present disclosure. As shown, example 500 includes a network node 110, a UE 120, and the RIS 160. The RIS 160 may be controlled and/or configured by the RIS controller 410.

As shown in FIG. 5, the UE 120 may receive a communication (e.g., data and/or control information) directly from the network node 110 as a downlink communication. Additionally, or alternatively, the UE 120 may receive a communication (e.g., data and/or control information) indirectly from the network node 110 via the RIS 160. For example, the network node 110 may transmit the communication in a spatial direction toward the RIS 160, and the RIS 160 may redirect or reflect the communication to the UE 120.

In some examples, the UE 120 may communicate directly with the network node 110 via a direct link 505. For example, a communication may be transmitted via the direct link 505. A communication transmitted via the direct link 505 between the UE 120 and the network node 110 does not pass through and is not reflected or redirected by the RIS 160. In some examples, the UE 120 may communicate indirectly with the network node 110 via an indirect link 510. For example, a communication may be transmitted via different segments of the indirect link 510. A communication transmitted via the indirect link 510 between the UE 120 and the network node 110 is reflected and/or redirected by the RIS 160. As shown in FIG. 5 and by reference number 515, the network node 110 may communicate with the RIS 160 (e.g., with the RIS controller 410) via a control channel. For example, the network node 110 may indicate, in an RIS control message, spatial direction(s) and/or signal characteristics for signals reflected by the RIS 160. The RIS controller 410 may configure reconfigurable elements of the RIS 160 in accordance with the RIS control message. In some examples, the RIS control message may indicate information associated with the wireless network, such as a frame structure, time synchronization information, and/or slot boundaries, among other examples. Using the communication scheme shown in FIG. 5 may improve network performance and increase reliability by providing the UE 120 with link diversity for communicating with the network node 110.

In some cases, the UE 120 may receive a communication (e.g., the same communication) from the network node 110 via both the direct link 505 and the indirect link 510. In other cases, the network node 110 may select one of the links (e.g., either the direct link 505 or the indirect link 510), and may transmit a communication to the UE 120 using only the selected link. Alternatively, the network node 110 may receive an indication of one of the links (e.g., either the direct link 505 or the indirect link 510), and may transmit a communication to the UE 120 using only the indicated link. The indication may be transmitted by the UE 120 and/or the RIS 160. In some examples, such selection and/or indication may be based at least in part on channel conditions and/or link reliability.

As indicated above, FIG. 5 is provided as an example. Other examples may differ from what is described with respect to FIG. 5.

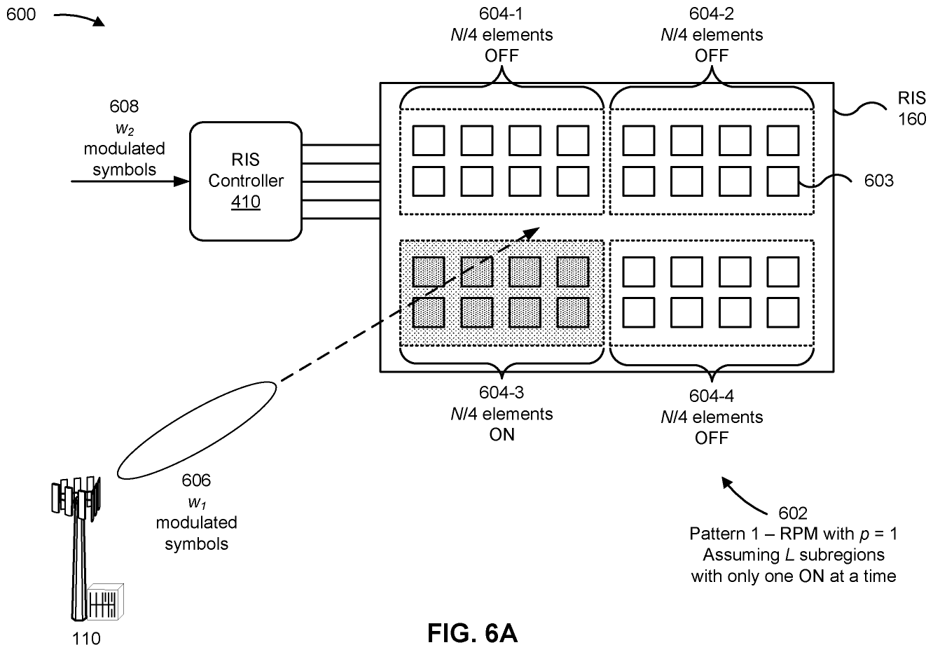

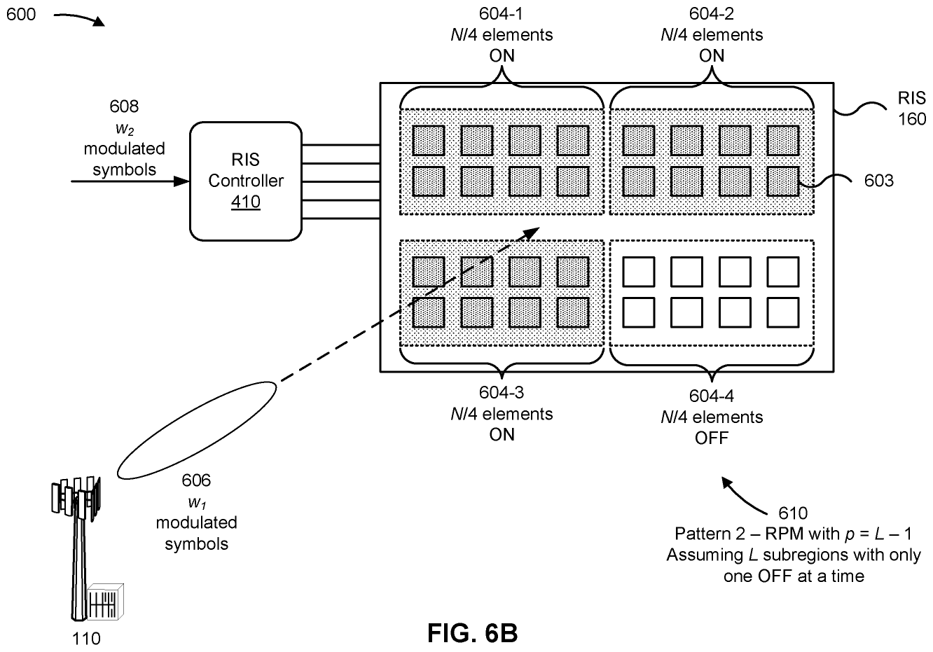

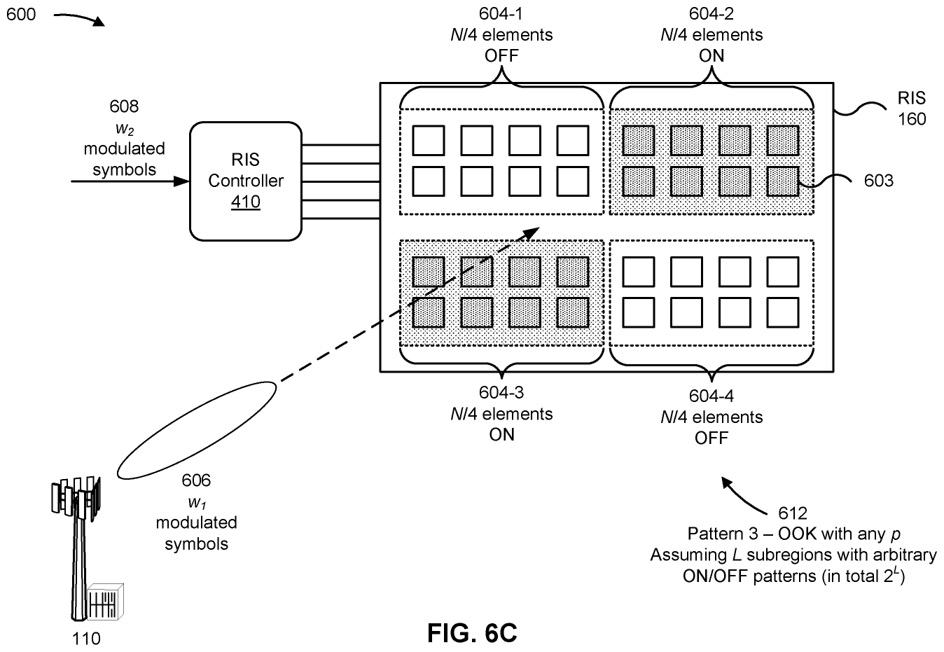

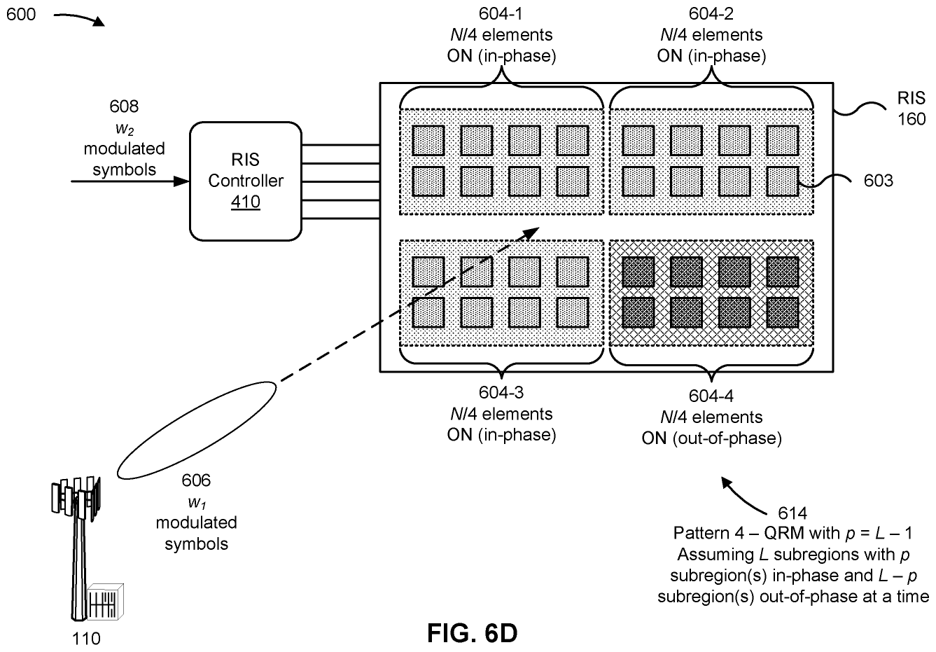

FIGS. 6A-6D are diagrams illustrating an example 600 of energy-efficient information transfer via reconfigurable intelligent surface partitioning, in accordance with the present disclosure.

In some cases, the RIS controller 410 may not be capable of directly transmitting a communication to a network entity (e.g., a modem of the RIS controller 410 may not have transmit capabilities) or else may be configured to transmit communications infrequently and/or under a limited power budget. This may make it difficult to effectively incorporate RISs 160 into a cellular framework due to the RIS's lack of ability to share its own data (e.g., control data) with other network entities. In some examples, the RIS 160 may thus utilize PBIT to communicate with other network entities (e.g., network nodes 110, UEs 120, and/or other RISs), such as to share RIS data (e.g., control data) with other network entities. In PBIT, a signal transmitted by a network node 110 or other network entity (such as the signal 415 described in connection with FIG. 4) is selectively reflected off of a reflective surface of the RIS 160 in order to modulate information bits into the reflected signal (e.g., the reflected signal described above in connection with reference number 420).

For example, the RIS 160 may include a number of scattering elements (sometimes referred to as reflective elements) partitioned into a number of sub-surfaces, and the sub-surfaces may be selectively activated, deactivated, or otherwise configured to enable joint encoding and beamforming at the RIS 160. Partitioning the scattering elements into a number of sub-surfaces may reduce a complexity of control wiring at the RIS 160, because the group of scattering elements may be controlled together. Additionally, or alternatively, partitioning the scattering elements into a number of sub-surfaces may reduce power consumption at the RIS 160, because certain sub-surfaces may be turned off to lower power requirements. However, switching off some sub-surfaces of the RIS 160 may lead to a lower beamforming gain, which may result in QoS problems on the scheduled UEs 120 or other network entities receiving the reflected beam.

In some examples, RIS partitioning may be utilized to implement a PBIT scheme through index modulation (IM). IM may refer to an ability to convey information by the indices of transmit/receive resources (e.g., antennas). Accordingly, for an RIS 160 partitioned into multiple sub-surfaces, the index of RIS sub-surfaces in on and off states may be used to transmit data as per an IM technique, such as one of a reflection pattern modulation (RPM) technique, an OOK technique, a quadrature receive modulation (QRM) technique, or similar PBIT technique implementing RIS partitioning.

More particularly, FIG. 6A shows an example of a first RPM PBIT scheme 602, sometimes referred to herein as pattern 1. As shown in FIG. 6A, a reflective surface of the RIS 160 may include a number (e.g., N) of reflective elements 603 that are partitioned into a number (e.g., L) of subregions 604 (shown as subregion 604-1 through subregion 604-4 in FIGS. 6A-6D). In that regard, each subregion 604 may include a grouping of N/L reflective elements 603 (e.g., in the depicted example, the RIS 160 may include 32 reflective elements partitioned into four subregions 604, and thus each subregion 604 may include eight reflective elements 603). As described above, each of the reflective elements 603 associated with a given subregion 604 may be controlled together.

In RPM PBIT schemes, a number (e.g., p) of the subregions 604 may be selectively turned off or on to modulate information onto a reflective signal. For example, in the first RPM PBIT scheme, only one subregion 604 may be used at a time to reflect a signal (e.g., p=1), with the particular subregion 604 being used at any given time varying according to data being encoded on the reflected signal. More particularly, a network node 110 may transmit a signal toward the RIS 160 that includes a first set of modulated symbols 606 (sometimes referred to as w₁) encoded thereon. The RIS 160 may in turn encode a second set of modulated symbols 608 (sometimes referred to as w₂), which may correspond to data associated with the RIS 160 (e.g., sensor data or similar data, which is described more fully below in connection with FIG. 7), by selectively turning on and off the various subregions 604 according to an IM scheme. For example, at the point in time shown in FIG. 6A, the RIS controller 410 may turn off a first subregion 604-1, a second subregion 604-2, and a fourth subregion 604-4, and thus reflect the signal using only a third subregion 604-3. Doing so may correspond to a first index or string of bits recognizable by the UE 120. The RIS controller 410 may vary which subregion 604 is on at any given time, and thus what index and/or bits are encoded into the reflected signal, thereby encoding a string of bits into the reflected signal which may be received and decoded by a UE 120 or other network entity receiving the reflected signal.

In some examples, using the first RPM PBIT scheme 602 may result in a relatively low power consumption at the RIS 160, because only one subregion 604 is active at any given time. Thus, for a RIS 160 including four subregions 604, a power consumption at the RIS 160 to employ the first RPM PBIT scheme 602 may be equal to one-fourth of the power required to operate all reflective elements 603 of the RIS 160, sometimes referred to as Pᵣᵢₛ (e.g., the power consumed by the first RPM PBIT scheme 602 may be equal to Pᵣᵢₛ/4). However, an amount of data that may be communicated using the first RPM PBIT scheme 602 may be limited, because only two bits of data may be conveyed per RIS configuration. Put another way, because the first RPM PBIT scheme 602 includes only four distinct states or configurations (e.g., a first state or configuration in which only the first subregion 604-1 is turned on, a second state or configuration in which only the second subregion 604-2 is turned on, a third state or configuration in which only the third subregion 604-3 is turned on, and a fourth state or configuration in which only the fourth subregion 604-4 is turned on), the number of bits that may be conveyed by each distinct state or configuration is equal to log₂ 4 bits (e.g., 2 bits). More particularly, each distinct state or configuration may be associated with one of bit strings of 00, 01, 11, or 11. Moreover, a realized beamforming gain may be relatively poor, because only one-fourth of the total reflective elements 603 of the RIS 160 are being utilized at any one time.

In some examples, in order to improve a beamforming gain associated with an RPM PBIT scheme, a second RPM PBIT scheme 610 (sometimes referred to herein as pattern 2) may be implemented by the RIS 160, as shown in FIG. 6B. In the second RPM PBIT scheme 610, three subregions 604 may be used at a time to reflect a signal (e.g., p=3), with the remaining subregion 604 being left off. More particularly, at the point in time shown in FIG. 6B, the RIS controller 410 may turn on (and thus reflect the signal using) the first subregion 604-1, the second subregion 604-2, and the third subregion 604-3, and the RIS controller 410 may leave the fourth subregion 604-4 off. Doing so may correspond to a first index or string of bits. The RIS controller 410 may vary which subregion 604 is off at any given time, and thus what information bit or bits are encoded into the reflected signal, according to the second set of modulated symbols 608, thereby encoding a string of bits into the reflected signal which may be received and decoded by a UE 120 or other network entity receiving the reflected signal.

Using the second RPM PBIT scheme 610 may increase a beamforming gain as compared to the first RPM PBIT scheme 602 because more reflective elements 603 are used to reflect the signal to the UE 120 or similar network entity. However, the second RPM PBIT scheme 610 may result in a relatively high power consumption, because three subregions 604 are active at any given time. Thus, for an RIS 160 including four subregions 604, a power consumption at the RIS 160 to employ the second RPM PBIT scheme 610 may be equal to three-fourths of the power required to operate all reflective elements 603 (e.g., the power consumed by the second RPM PBIT scheme 610 may be equal to 3Pᵣᵢₛ/4). Moreover, in a similar manner to the first RPM PBIT scheme, only two bits of data may be conveyed per RIS configuration because the second RPM PBIT scheme 610 similarly includes only four distinct states or configurations (e.g., a first state or configuration in which only the first subregion 604-1 is turned off, a second state or configuration in which only the second subregion 604-2 is turned off, a third state or configuration in which only the third subregion 604-3 is turned off, and a fourth state or configuration in which only the fourth subregion 604-4 is turned off).

In some examples, in order to increase a number of potential states formed by the selective activation of the subregions 604, and thus a number of information bits that may be conveyed per RIS configuration, an OOK PBIT scheme 612 (sometimes referred to herein as pattern 3) may be implemented by the RIS 160, as shown in FIG. 6C. In the OOK PBIT scheme 612, any number of subregions 604 may be used at a time to reflect a signal. More particularly, at the point in time shown in FIG. 6C, the RIS controller 410 may turn on (and thus reflect the signal using) the second subregion 604-2 and the third subregion 604-3, and the RIS controller 410 may leave the first subregion 604-1 and the fourth subregion 604-4 off. Doing so may correspond to a first index or string of bits. The RIS controller 410 may vary how many and which subregions 604 are on and off at any given time, and thus what information bit or bits are encoded into the reflected signal, thereby encoding a string of bits into the reflected signal which may be received and decoded by a UE 120 or other network entity receiving the reflected signal.

Using the OOK PBIT scheme 612 may increase a number of RIS configurations (e.g., states) that can be used to reflect a signal, and thus may increase a number of information bits that may be conveyed per RIS configuration. More particularly, the RIS controller 410 may selectively choose one of 2^{L} on/off patterns of the subregions 604 (e.g., 2⁴, or 16 patterns in the example shown in FIG. 6C), and thus the OOK PBIT scheme 612 may be capable of conveying four bits of information per RIS configuration (e.g., log₂ 16=4 bits). Put another way, each state associated with the OOK PBIT scheme 612 may be capable of indicating one of 0000, 0001, 0010, 0011, 0100, 0101, 0110, 0111, 1000, 1001, 1010, 1011, 1100, 1101, 1110, or 1111. Moreover, the OOK PBIT scheme 612 may result in a decreased power consumption as compared to the second RPM PBIT scheme 610, because at certain times less than three subregions 604 may be used to encode bits into the reflected signal (e.g., in some aspects, an average power consumption may be less than 3Pᵣᵢₛ/4). For example, in the state shown in FIG. 6C, only two subregions 604 are being utilized to transmit the signal, however, at other times, zero, one, three, or four subregions 604 may be used to thereby encode different strings of bits into the reflected signal. However, the OOK PBIT scheme 612 may result in a higher error rate than the second RPM PBIT scheme 610, because the varied patterns may be transmitted using an overall lower transmit power and/or the varied patterns may be difficult to distinguish by a UE 120 or other network device receiving the reflected signal.

In some examples, in order to communicate with as many patterns as may be achieved by using the OOK PBIT scheme 612 while reducing an error performance associated with the PBIT scheme, a QRM PBIT scheme 614 (sometimes referred to herein as pattern 4) may be used, as shown in FIG. 6D. In the QRM PBIT scheme 614, all available subregions 604 may be used at a time to reflect a signal, with any number (e.g., zero to four in the depicted example) of the subregions 604 used to reflect the signal in-phase, and the remaining subregions 604 used to reflect the signal out-of-phase (e.g., with a phase shift of π, π/2, or other suitable phase shift). More particularly, at the point in time shown in FIG. 6D, the RIS controller 410 may turn on, in an in-phase configuration, the first subregion 604-1, the second subregion 604-2, and the third subregion 604-3, to thereby reflect the signal in an in-phase manner. The RIS controller 410 may further turn on, in an out-of-phase configuration, the remaining subregions 604 (which corresponds to the fourth subregion 604-4 in the example shown in FIG. 6D), to thereby reflect the signal in an out-of-phase manner (e.g., to thereby reflect the signal with a phase shift of π, π/2, or other suitable phase shift). The RIS controller 410 may vary which subregions 604 are on and in an in-phase configuration and thus which subregions 604 are on but in an out-of-phase configuration at any given time, and thus what information bit or bits are encoded into the reflected signal, thereby encoding a string of bits into the reflected signal which may be received and decoded by a UE 120 or other network entity receiving the reflected signal.

Using the QRM PBIT scheme 614 may increase a number of RIS configurations (e.g., states) that can be used to reflect a signal, and thus may increase a number of information bits that may be conveyed per RIS configuration. More particularly, and in a similar manner to the OOK PBIT scheme 612, the RIS controller 410 may selectively choose one of 2^{L} on, in-phase/on, out-of-phase patterns of the subregions 604 (e.g., 2⁴, or 16 patterns in the example shown in FIG. 6D), and thus the QRM PBIT scheme 614 may be capable of conveying four bits of information per RIS configuration (e.g., log₂ 16=4 bits). Moreover, the QRM PBIT scheme 614 may result in a reduced error rate as compared to the OOK PBIT scheme 612, because, by using all four subregions 604 to encode the information bits, the reflected signal may have a higher beamforming gain and/or the encoded patterns may be more distinguishable at the UE 120. However, the QRM PBIT scheme 614 may result in an increased power consumption as compared to the OOK PBIT scheme 612, because all subregions 604 are used, and thus the power consumed by the QRM PBIT scheme 614 may correspond to the power required to operate all reflective elements 603 (e.g., Pᵣᵢₛ).

Accordingly, depending on what PBIT scheme is employed by an RIS 160, a UE 120 may experience high error rates and/or a RIS 160 may experience high power consumption. For example, certain PBIT schemes implemented by an RIS 160 (e.g., PBIT schemes associated with a low beamforming gain or hard-to-distinguish patterns) may result in high communication errors at a UE 120, requiring high retransmission rates and/or other resource expenditure to correct communication errors. On the other hand, an RIS 160 may employ a high-power-consuming PBIT scheme to increase beamforming gain or otherwise improve a communication link between the RIS 160 and the UE 120, which may result in unnecessary energy expenditure at the RIS 160 for low QoS applications and/or applications that can otherwise tolerate relatively high communication errors.

Some techniques and apparatuses described herein enable energy-efficient PBIT schemes for communication by an RIS (e.g., RIS 160). In some aspects, a network node (e.g., a network node 110, a CU, a DU, and/or an RU) may select one of multiple PBIT schemes to be used by an RIS based at least in part on at least one of energy consumption of the selected PBIT scheme or an error performance of the selected PBIT scheme. For example, for high QoS applications and/or applications requiring a low error rate, the network node may select a PBIT scheme exhibiting good error performance albeit with high power consumption. In other applications, such as low QoS applications and/or applications in which a relatively high error rate is acceptable, the network may select a PBIT scheme exhibiting low power consumption. Additionally, or alternatively, the network node may select a PBIT scheme associated with virtual partitions and/or all-zero-free OOK in order to improve an error performance associated with the PBIT scheme. As a result, the techniques and apparatuses described herein may improve communication performance and efficiency by enabling flexible selection of an appropriate PBIT scheme for a given RIS application.

As indicated above, FIGS. 6A-6D are provided as an example. Other examples may differ from what is described with respect to FIGS. 6A-6D.

FIG. 7 is a diagram of an example 700 associated with energy-efficient information transfer via RIS partitioning, in accordance with the present disclosure. As shown in FIG. 7, a network node 110 (e.g., a CU, a DU, and/or an RU), an RIS 160 (e.g., RIS 160), and a network device 705 (e.g., a UE 120 or another network device, such as another network node 110, another RIS 160, or a similar device) may communicate with one another. In some aspects, the network node 110, the RIS 160, and the network device 705 may be part of a wireless network (e.g., wireless network 100). The network node 110, the RIS 160, and/or the network device 705 may have established a wireless connection prior to operations shown in FIG. 7. For example, the network node 110 and the network device 705 may have established a wireless connection via a direct link (e.g., direct link 505) and/or via an indirect link (e.g., indirect link 510) via the RIS 160.

As shown by reference number 710, the network node 110 may select a PBIT scheme that is to be used by the RIS 160 to communicate information available to the RIS to the network device 705. For example, the network node 110 may select one of the first RPM PBIT scheme 602 described above in connection with FIG. 6A, the second RPM PBIT scheme 610 described above in connection with FIG. 6B, the OOK PBIT scheme 612 described above in connection with FIG. 6C, or the QRM PBIT scheme 614 described above in connection with FIG. 6D. In some aspects, the network node 110 may select a PBIT scheme that is to be used by the RIS 160 to communicate information available to the RIS to the network device 705 based at least in part on at least one of energy consumption of the PBIT scheme or an error performance of the PBIT scheme. Put another way, the network node 110 may select a most energy-efficient PBIT scheme, out of multiple potential PBIT schemes, that is capable of meeting a QoS and/or error performance of a particular use case and/or application.

In some aspects, the network node 110 may select some variation of the PBIT schemes described above in connection with FIGS. 6A-6D. For example, the PBIT schemes 602, 610, 612, 614 shown in FIGS. 6A-6D may involve turning certain subregions 604 on or off and/or configuring certain subregions to be in-phase or out-of-phase in order to encode a reflected signal with information bits. In some aspects, the subregions 604 may be associated with physical partitions at the RIS 160. That is, each subregion 604 may be associated with a number of a number (e.g., N) of reflective elements 603 that are wired alike and/or controlled together, which may be referred to as a physical partition of the RIS 160. In some aspects, using these physical partitions may result in a relatively high error rate in the communication received at the network device 705, because the network device 705 may be unable to effectively distinguish between the multiple patterns (and thus string of information bits) being used by the RIS 160.

Accordingly, in some aspects, the selected PBIT scheme may be associated with virtual PBIT partitions, such as for purposes of improving an error performance of one of the PBIT schemes 602, 610, 612, 614 described above in connection with FIGS. 6A-6D. A virtual partition may include a grouping of one or more physical partitions (e.g., subregions 604) that are operated together during a PBIT scheme (e.g., the physical partitions belonging to a same virtual partition are turned on or off together, are configured as in-phase or out-of-phase together, or are similarly operated together). Put another way, in some aspects, the PBIT schemes available for selection by the network node 110 may be permitted to include a different RIS partitioning than the physical partitions associated with the RIS 160. Additionally, or alternatively, the virtual partitions may be associated with a flexible size (e.g., a size selected by the network node 110) and/or may include a same number of reflective elements 603 or more reflective elements 603 than the physical partitions (e.g., subregions 604). Returning to the examples described in connection with FIGS. 6A-6D, the RIS 160 may be associated with a number of physical partitions for beamforming purposes (e.g., L), and the RIS 160 may be configured with a number of virtual partitions for a particular PBIT scheme (sometimes referred to herein as r), which may be less than or equal to the number of physical partitions used for beamforming purposes (e.g., r≤L).

More particularly, the PBIT schemes 602, 610, 612, 614 described above in connection with FIGS. 6A-6D may assume that a same number of partitions may be used for the beamforming purposes (e.g., L) and for the PBIT scheme (e.g., r), which may degrade the performance of PBIT since the corresponding detector (e.g., at the receiver, such as the network device 705) generally may not be able to distinguish one pattern from many other patterns. Accordingly, the network node 110 may select a number of virtual partitions (e.g., r, with r≤L) to achieve a desired error performance for a given application. In that regard, in some aspects, a different number of RIS partitions may be used for beamforming and PBIT purposes (e.g., in some applications r≠L). For example, an OOK PBIT scheme may achieve a best error performance for PBIT by using virtual PBIT partitions with r<L (e.g., r=L/2) while keeping the RIS power consumption at the lowest level. More particularly, in one example, an OOK PBIT scheme utilizing virtual PBIT partitioning may require less power consumption at the RIS 160 by 12% compared to a best performing RPM PBIT scheme, and by 34% compared to a best performing QRM PBIT scheme. In some aspects, when r<L, a power consumption associated with the RIS 160 may increase as compared to a PBIT scheme in which r=L and/or a number of information bits that may be indicated per RIS configuration may be reduced as compared to a PBIT scheme in which r=L. For example, when the RIS 160 is associated with four physical partitions for purposes of beamforming (e.g., L=4) and two virtual partitions are used for purposes on an OOK PBIT scheme (e.g., r=2), a power consumption at the RIS 160 may be equal to 2Pᵣᵢₛ/3, and a number of bits that may be conveyed per RIS configuration may be equal to log₂ 3, which is approximately equal to 1.6.

Additionally, or alternatively, in some aspects, the selected PBIT scheme may be associated with an OOK scheme associated with only non-all-zero patterns, such as for purposes of improving an error performance of the OOK PBIT scheme 612 described above in connection with FIG. 6C. More particularly, traditional OOK PBIT schemes, such as the OOK PBIT scheme 612, may be associated with an all-zero pattern, in which some information bits may be indicated by the RIS 160 turning off all subregions 604, such that no signal is reflected by the RIS 160 at that point in time. Thus, when the all-zero pattern is used at the RIS 160, a network device (e.g., a UE 120) may receive a signal via a direct link (e.g., direct link 505) and not an indirect link reflected off of the RIS 160 (e.g., indirect link 510). This may result in a saturation in error performance and thus a degraded communication link between the network node 110 and the network device. Accordingly, in some aspects, the network node 110 may select an OOK PBIT scheme associated with only non-all-zero patterns, which may result in an improved error performance as compared to traditional OOK PBIT schemes and/or an error performance of an OOK PBIT scheme competitive to other PBIT schemes (e.g., QRM PBIT schemes, OOK PBIT schemes using virtual partitioning, or similar PBIT schemes), and/or may result in an OOK PBIT scheme associated with only non-all-zero patterns being a best choice in some use cases.

In some aspects, the network node 110 may select an RPM PBIT scheme to minimize a penalty for the network node 110 error performance degradation, and, in some other aspects, the network node 110 may select an OOK PBIT scheme to prioritize energy performance and/or PBIT error performance. For example, in some aspects, an RPM PBIT scheme (p=3, r=4) and a QRM PBIT scheme (p={1,3}, r=4) may achieve the best error performance for network node 110 transmitted data (e.g., by paying for the least penalty compared to the without-PBIT scheme), and the RPM PBIT scheme (p=3, r=4) may be approximately 25% more energy efficient than the QRM PBIT scheme (p={1,3}, r=4). Accordingly, based at least in part on the particular application, data to be transmitted, or similar considerations, the network node 110 may select a PBIT scheme to be used by the RIS 160, including, in some aspects, selecting a number of virtual partitions (e.g., r) to be utilized by the RIS 160 for purposes of PBIT.

As shown by reference number 715, the network node 110 may transmit, and the RIS 160 may receive, configuration information. In some aspects, the RIS 160 may receive the configuration information via one or more of RRC signaling, one or more MAC control elements (MAC-CEs), and/or downlink control information (DCI), among other examples. In some examples, the configuration information may be transmitted to an RIS controller (e.g., RIS controller 410) and/or the configuration information may be transmitted via an RIS control message (similar to the RIS control message described above in connection with reference number 515). In some aspects, the configuration information may include an indication of one or more configuration parameters (e.g., already known to the RIS 160 and/or previously indicated by the network node 110 or other network device) for selection by the RIS 160, and/or explicit configuration information for the RIS 160 to use to configure the RIS 160, among other examples.

In some aspects, the configuration information may indicate a PBIT scheme that is to be used by the RIS 160 to communicate information available to the RIS to the network device 705. For example, the configuration information may indicate the PBIT scheme selected by the network node 110 in connection with the operations described above in connection with reference number 710. Additionally, or alternatively, the configuration information may indicate certain parameters associated with the selected PBIT scheme, such as a number of virtual partitions (e.g., r) associated with the selected PBIT scheme. In that regard, the configuration information may be based at least in part on at least one of energy consumption of the PBIT scheme or an error performance of the PBIT scheme, as described above in connection with reference number 710.

In some aspects, the configuration information (and thus a selection of the PBIT scheme and/or associated parameters, such as the number of virtual partitions to be used) may be based at least in part on a capability of an RIS controller associated with the RIS 160 (e.g., RIS controller 410). For example, the configuration information may be based at least in part on the RIS controller having a capability to receive communications from the network node 110 and not having a capability to transmit communications to the network node 110. That is, in some examples, the RIS controller may have receive capability only (e.g., an RIS controller implemented onto low-cost and/or strictly power-limited devices) so that RIS 160 shares its own data with the network node 110 in the uplink (and, in some cases, to a UE 120 in the downlink) through PBIT. For example, the RIS 160, through PBIT, may share data such as sensor data (e.g., temperature), maintenance status data (e.g., internal test results), battery life data, an indication denoting if the RIS 160 is already assisting an ongoing communication between network entities, or similar data, which is described in more detail below in connection with reference numbers 730 and 740. In some aspects, this RIS data to be indicated by PBIT may be utilized by the network node 110 and/or the network device 705 (e.g., a UE 120). For example, a UE 120 may receive the RIS data (e.g., an indication of a remaining battery of the RIS 160, an indication of a failure in internal tests performed by the RIS 160, or similar information) by PBIT in the downlink, and the UE 120 may sends the RIS data quickly to the network node 110 (e.g., via a physical uplink control channel (PUCCH)) to avoid any link failure. Additionally, or alternatively, the network node 110 may plan to schedule another RIS 160 (or any other available relay, such as a repeater or similar relay) to assist a communication if the received RIS data via PBIT indicates any future link failure or similar information.

In some other aspects, the configuration information (and thus a selection of the PBIT scheme and/or associated parameters, such as the number of virtual partitions to be used) may be based at least in part on an RIS controller (e.g., RIS controller 410) associated with the RIS 160 having a capability to receive communications from the network node 110 and the RIS controller having a capability to transmit communications to the network node 110. More particularly, for aspects in which the RIS controller has both a receive and a transmit capability, the RIS controller may be configured to avoid transmitting the RIS data as much as possible for energy-saving purposes, and the RIS 160 may thus share data in the downlink and uplink through a selected PBIT scheme.

The RIS 160 may configure itself based at least in part on the configuration information. In some aspects, the RIS 160 may be configured to perform one or more operations described herein based at least in part on the configuration information. Moreover, because a selected PBIT scheme (e.g., one of the PBIT schemes 602, 610, 612, 614, with or without virtual partitioning and/or only non-all-zero patterns) need not be associated with separate time-frequency resources or separate beam(s) (as compared to the time-frequency resources associated with a direct link between the network node 110 and the network device 705), the network node 110 may select and/or schedule a selected PBIT scheme by simply selecting and indicating a suitable RIS configuration.

As shown by reference numbers 720-735, the network node 110, the RIS 160, and/or the network device 705 may communicate based at least in part on the selected PBIT scheme. For example, the RIS 160 may communicate information available to the RIS to the network device 705 based at least in part on the PBIT scheme by reflecting a signal associated with a communication from the network node 110 to the network device 705 (e.g., a downlink signal or similar signal), as shown by reference number 720. More particularly, the RIS 160 may encode the reflected signal with the information available to the RIS by using the selected PBIT scheme, as shown by reference number 730. In some aspects, the signal described in connection with reference number 720 may be transmitted directly from the network node 110 to the network device 705, such as via a direct link (e.g., direct link 505), as well as transmitted indirectly from the network node 110 to the network device 705, such as via an indirect link (e.g., indirect link 510) via the RIS 160.

Similarly, the RIS 160 may communicate information available to the RIS to the network node 110 based at least in part on the PBIT scheme by reflecting a signal associated with a communication from the network device 705 to the network node 110 (e.g., an uplink signal), as shown by reference number 735. More particularly, the RIS 160 may encode the reflected signal with the information available to the RIS by using the selected PBIT scheme, as shown by reference number 740. In some aspects, the signal described in connection with reference number 730 may be transmitted directly from the network device 705 to the network node 110, such as via a direct link (e.g., direct link 505), as well as transmitted indirectly from the network device 705 to the network node 110, such as via an indirect link (e.g., indirect link 510) via the RIS 160.

In some aspects, and as described above in connection with reference numbers 710 and 715, communicating the information available to the RIS to the network device 705 and/or the network node 110 based at least in part on the PBIT scheme may include communicating data associated with the RIS 160 to the network device 705 and/or to the network node 110. More particularly, communicating the data associated with the RIS 160 to the network device 705 and/or the network node 110 may include communicating sensor data associated with the RIS 160, an indication of a maintenance status associated with the RIS 160, an indication of a battery life associated with the RIS 160, and/or an indication of whether the RIS is assisting an ongoing communication between network entities.

Additionally, or alternatively, in some aspects, it may be desirable for a network entity (e.g., the network device 705 and/or the network node 110) to distinguish between non-RIS and RIS-reflected paths, such as for more accurate positioning determinations or similar purposes. Accordingly, in some aspects, the network node 110 may select and/or schedule a PBIT scheme to mark the RIS-reflected paths. For example, the presence of the RIS 160 may deteriorate the positioning accuracy in the downlink for a positioning reference signal (PRS)-based scheme if the RIS-reflected path is not distinguished from natural, non-RIS paths. Thus, in some aspects, communicating the information available to the RIS to the network device 705 based at least in part on the PBIT scheme may include encoding an RIS-reflected beam with an indication that the RIS-reflected beam is reflected off of the RIS 160. More particularly, the RIS-reflected beam may be associated with a PRS, and one or more PRS beams reflected off the RIS 160 may be marked by encoding proper information at the RIS 160 using the selected PBIT scheme. In this way, the network device 705 may be able to classify the RIS-reflected PRS beams to use separately (without triggering any confusion which may degrade downlink positioning accuracy). Similarly, the presence of the RIS 160 may deteriorate the positioning accuracy in the uplink for a sounding reference signal (SRS)-based scheme if the RIS-reflected path is not distinguished from natural, non-RIS paths. Accordingly, in some aspects (e.g., in aspects involving uplink positioning), the RIS-reflected beam may be associated with an SRS, and one or more SRS beams reflected off the RIS 160 may be marked by encoding proper information at the RIS 160 using the selected PBIT scheme. In some aspects, marking PRS beams and/or SRS beams with an indication that the beam is reflected off the RIS 160 may improve positioning (e.g., by treating the RIS 160 as an additional anchor).

In some aspects, a PBIT scheme may be selected to enable inter-RIS communication, such as when information is exchanged between multiple RISs 160 for purposes of interference management. For example, the network device 705 may be another RIS 160, and/or communicating the information available to the RIS to the network device 705 based at least in part on the PBIT scheme may include encoding an RIS identifier on an RIS-reflected beam. More particularly, the network node 110 may assign a unique identifier (e.g., an RIS identifier) to each of multiple RISs 160 within the network node 110's coverage area. Each of the multiple RISs 160 may be capable of encoding a corresponding RIS identifier onto a reflecting beam using the selected PBIT scheme. For example, the RIS 160 may encode its RIS identifier onto the reflected beam, which may be received by another RIS 160 (and thus potentially reflected based on the configuration of the other RIS 160). In such aspects, the receiver (e.g., the network device 705), upon acquiring the double-reflected beam, may decode the RIS-originated message and thus may end up with two separate RIS identifiers indicating two separate RISs 160 assisting the network device 705′s reception. Additionally, or alternatively, in some aspects, the network device 705 may be experiencing interference, and thus may request the network node 110 to configure channel state information (CSI) reference signal (CSI-RS) resources for interference measurements. Accordingly, the network node 110 may configure the adequate CSI-RS resources to enable the network device 705 to perform interference measurements, and/or the network node 110 may configure the various RISs 160 within the network node 110's coverage (e.g., by sending appropriate control signaling to the respective RIS controllers) to insert the respective identifier of each RIS 160 in the reflected beams reflected by that RIS 160 so that the network device 705 may resolve the source of interference by checking the RIS identifiers.

By the network node 110 selecting and/or configuring the RIS 160 with a PBIT scheme based at least in part on at least one of energy consumption of the selected PBIT scheme or an error performance of the selected PBIT scheme, the RIS 160 and/or the network node 110 may conserve computing, power, network, and/or communication resources that may have otherwise been consumed by PBIT operations. For example, by the network node 110 selecting and/or configuring the RIS 160 with a PBIT scheme based at least in part on at least one of energy consumption of the selected PBIT scheme or an error performance of the selected PBIT scheme, the RIS 160 and the network node 110 may communicate with reduced power consumption and/or a reduced error rate, which may conserve computing, power, network, and/or communication resources that may have otherwise been consumed to detect and/or correct communication errors.

As indicated above, FIG. 7 is provided as an example. Other examples may differ from what is described with respect to FIG. 7.

FIG. 8 is a diagram illustrating an example process 800 performed, for example, by an RIS, in accordance with the present disclosure. Example process 800 is an example where the RIS (e.g., RIS 160) performs operations associated with energy-efficient information transfer via RIS partitioning.

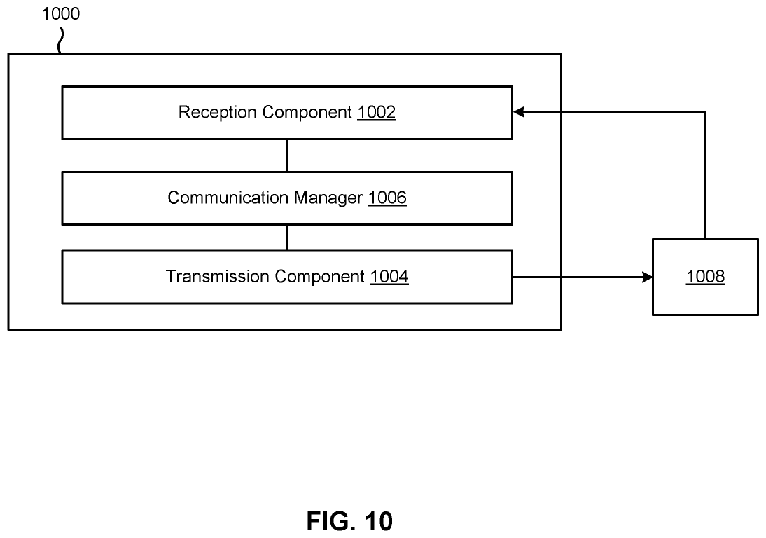

As shown in FIG. 8, in some aspects, process 800 may include receiving configuration information indicating a PBIT scheme, the configuration information being based at least in part on at least one of energy consumption of the PBIT scheme or an error performance of the PBIT scheme (block 810). For example, the RIS (e.g., using reception component 1002 and/or communication manager 1006, depicted in FIG. 10) may receive configuration information indicating a PBIT scheme, the configuration information being based at least in part on at least one of energy consumption of the PBIT scheme or an error performance of the PBIT scheme, as described above.

As further shown in FIG. 8, in some aspects, process 800 may include communicating information available to the RIS to the network device based at least in part on the PBIT scheme (block 820). For example, the RIS (e.g., using reception component 1002, transmission component 1004, and/or communication manager 1006, depicted in FIG. 10) may communicate information available to the RIS to the network device based at least in part on the PBIT scheme, as described above.

Process 800 may include additional aspects, such as any single aspect or any combination of aspects described below and/or in connection with one or more other processes described elsewhere herein.

In a first aspect, communicating the information available to the RIS to the network device based at least in part on the PBIT scheme includes communicating data associated with the RIS to the network device.

In a second aspect, alone or in combination with the first aspect, communicating the data associated with the RIS to the network device includes communicating at least one of data associated with the RIS, an indication of a maintenance status associated with the RIS, an indication of a battery life associated with the RIS, or an indication of whether the RIS is assisting an ongoing communication between network entities.

In a third aspect, alone or in combination with one or more of the first and second aspects, the configuration information is based at least in part on an RIS controller associated with the RIS having a capability to receive communications from a network node and the RIS controller not having a capability to transmit communications to the network node.

In a fourth aspect, alone or in combination with one or more of the first through third aspects, the configuration information is based at least in part on an RIS controller associated with the RIS having a capability to receive communications from a network node and the RIS controller having a capability to transmit communications to the network node.

In a fifth aspect, alone or in combination with one or more of the first through fourth aspects, communicating the information available to the RIS to the network device based at least in part on the PBIT scheme includes encoding an RIS-reflected beam with an indication that the RIS-reflected beam is reflected off of the RIS.

In a sixth aspect, alone or in combination with one or more of the first through fifth aspects, the RIS-reflected beam is associated with a positioning reference signal.

In a seventh aspect, alone or in combination with one or more of the first through sixth aspects, the RIS-reflected beam is associated with a sounding reference signal.

In an eighth aspect, alone or in combination with one or more of the first through seventh aspects, communicating the information available to the RIS to the network device based at least in part on the PBIT scheme includes encoding an RIS identifier on an RIS-reflected beam.

In a ninth aspect, alone or in combination with one or more of the first through eighth aspects, the PBIT scheme is associated with virtual PBIT partitions.

In a tenth aspect, alone or in combination with one or more of the first through ninth aspects, the PBIT scheme is associated with an on-off keying scheme associated with only non-all-zero patterns.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with energy-efficient information transfer via RIS partitioning.

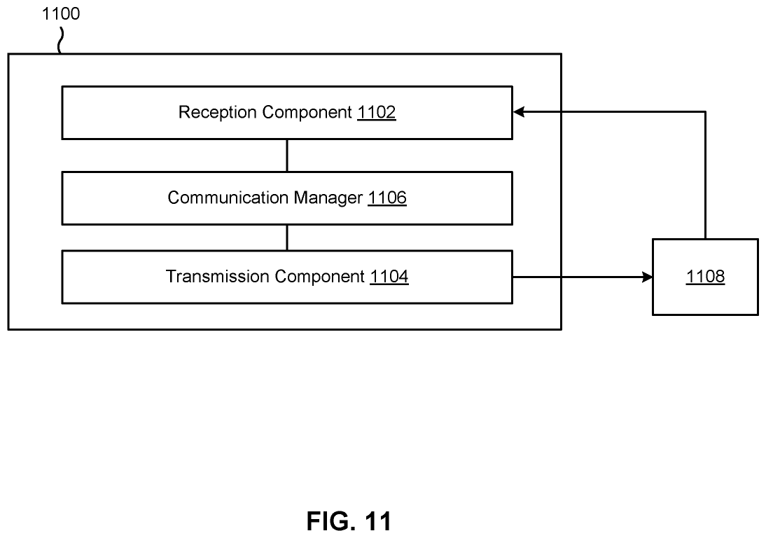

As shown in FIG. 9, in some aspects, process 900 may include selecting a PBIT scheme that is to be used by an RIS to communicate information available to the RIS to a network device based at least in part on at least one of energy consumption of the PBIT scheme or an error performance of the PBIT scheme (block 910). For example, the network node (e.g., using communication manager 1106, depicted in FIG. 11) may select a PBIT scheme that is to be used by an RIS to communicate information available to the RIS to a network device based at least in part on at least one of energy consumption of the PBIT scheme or an error performance of the PBIT scheme, as described above.

As further shown in FIG. 9, in some aspects, process 900 may include transmitting, to the RIS, configuration information indicating the PBIT scheme (block 920). For example, the network node (e.g., using transmission component 1104 and/or communication manager 1106, depicted in FIG. 11) may transmit, to the RIS, configuration information indicating the PBIT scheme, as described above.

Process 900 may include additional aspects, such as any single aspect or any combination of aspects described below and/or in connection with one or more other processes described elsewhere herein.

In a first aspect, the information available to the RIS includes data associated with the RIS.

In a second aspect, alone or in combination with the first aspect, the data associated with the RIS includes at least one of data associated with the RIS, an indication of a maintenance status associated with the RIS, an indication of a battery life associated with the RIS, or an indication of whether the RIS is assisting an ongoing communication between network entities.

In a third aspect, alone or in combination with one or more of the first and second aspects, selecting the PBIT scheme is based at least in part on an RIS controller associated with the RIS having a capability to receive communications from the network node and the RIS controller not having a capability to transmit communications to the network node.

In a fourth aspect, alone or in combination with one or more of the first through third aspects, selecting the PBIT scheme is based at least in part on an RIS controller associated with the RIS having a capability to receive communications from the network node and the RIS controller having a capability to transmit communications to the network node.

In a fifth aspect, alone or in combination with one or more of the first through fourth aspects, the information available to the RIS includes an indication that an RIS-reflected beam is reflected off of the RIS.

In a sixth aspect, alone or in combination with one or more of the first through fifth aspects, the RIS-reflected beam is associated with a positioning reference signal.

In a seventh aspect, alone or in combination with one or more of the first through sixth aspects, the RIS-reflected beam is associated with a sounding reference signal.

In an eighth aspect, alone or in combination with one or more of the first through seventh aspects, the information available to the RIS includes an RIS identifier encoded on an RIS-reflected beam.

In a ninth aspect, alone or in combination with one or more of the first through eighth aspects, the PBIT scheme is associated with virtual PBIT partitions.

In a tenth aspect, alone or in combination with one or more of the first through ninth aspects, the PBIT scheme is associated with an on-off keying scheme associated with only non-all-zero patterns.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be an RIS 160, or a RIS 160 may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 170 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE 120 described in connection with FIG. 2 (e.g., the apparatus 1000 may be associated with a UE modem 254). Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE 120 described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE 120 described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive configuration information indicating a PBIT scheme, the configuration information being based at least in part on at least one of energy consumption of the PBIT scheme or an error performance of the PBIT scheme. The reception component 1002 and/or the transmission component 1004 may communicate information available to the RIS to the network device based at least in part on the PBIT scheme.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node 110, or a network node 110 may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node 110 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node 110 described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network node 110 described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The communication manager 1106 may select a PBIT scheme that is to be used by an RIS to communicate information available to the RIS to a network device based at least in part on at least one of energy consumption of the PBIT scheme or an error performance of the PBIT scheme. The transmission component 1104 may transmit, to the RIS, configuration information indicating the PBIT scheme.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by an RIS, comprising: receiving configuration information indicating a PBIT scheme, the configuration information being based at least in part on at least one of energy consumption of the PBIT scheme or an error performance of the PBIT scheme; and communicating information available to the RIS to the network device based at least in part on the PBIT scheme.
Aspect 2: The method of Aspect 1, wherein communicating the information available to the RIS to the network device based at least in part on the PBIT scheme includes communicating data associated with the RIS to the network device.
Aspect 3: The method of Aspect 2, wherein communicating the data associated with the RIS to the network device includes communicating at least one of: sensor data associated with the RIS, an indication of a maintenance status associated with the RIS, an indication of a battery life associated with the RIS, or an indication of whether the RIS is assisting an ongoing communication between network entities.
Aspect 4: The method of any of Aspects 1-3, wherein the configuration information is based at least in part on an RIS controller associated with the RIS having a capability to receive communications from a network node and the RIS controller not having a capability to transmit communications to the network node.
Aspect 5: The method of any of Aspects 1-3, wherein the configuration information is based at least in part on an RIS controller associated with the RIS having a capability to receive communications from a network node and the RIS controller having a capability to transmit communications to the network node.
Aspect 6: The method of any of Aspects 1-5, wherein communicating the information available to the RIS to the network device based at least in part on the PBIT scheme includes encoding an RIS-reflected beam with an indication that the RIS-reflected beam is reflected off of the RIS.
Aspect 7: The method of Aspect 6, wherein the RIS-reflected beam is associated with a positioning reference signal.
Aspect 8: The method of Aspect 6, wherein the RIS-reflected beam is associated with a sounding reference signal.
Aspect 9: The method of any of Aspects 1-8, wherein communicating the information available to the RIS to the network device based at least in part on the PBIT scheme includes encoding an RIS identifier on an RIS-reflected beam.
Aspect 10: The method of any of Aspects 1-9, wherein the PBIT scheme is associated with virtual PBIT partitions.
Aspect 11: The method of any of Aspects 1-10, wherein the PBIT scheme is associated with an on-off keying scheme associated with only non-all-zero patterns.
Aspect 12: A method of wireless communication performed by a network node, comprising: selecting a PBIT scheme that is to be used by an RIS to communicate information available to the RIS to a network device based at least in part on at least one of energy consumption of the PBIT scheme or an error performance of the PBIT scheme; and transmitting, to the RIS, configuration information indicating the PBIT scheme.
Aspect 13: The method of Aspect 12, wherein the information available to the RIS includes data associated with the RIS.
Aspect 14: The method of Aspect 13, wherein the data associated with the RIS includes at least one of: sensor data associated with the RIS, an indication of a maintenance status associated with the RIS, an indication of a battery life associated with the RIS, or an indication of whether the RIS is assisting an ongoing communication between network entities.
Aspect 15: The method of any of Aspects 12-14, wherein selecting the PBIT scheme is based at least in part on an RIS controller associated with the RIS having a capability to receive communications from the network node and the RIS controller not having a capability to transmit communications to the network node.
Aspect 16: The method of any of Aspects 12-14, wherein selecting the PBIT scheme is based at least in part on an RIS controller associated with the RIS having a capability to receive communications from the network node and the RIS controller having a capability to transmit communications to the network node.
Aspect 17: The method of any of Aspects 12-16, wherein the information available to the RIS includes an indication that an RIS-reflected beam is reflected off of the RIS.
Aspect 18: The method of Aspect 17, wherein the RIS-reflected beam is associated with a positioning reference signal.
Aspect 19: The method of Aspect 17, wherein the RIS-reflected beam is associated with a sounding reference signal.
Aspect 20: The method of any of Aspects 12-19, wherein the information available to the RIS includes an RIS identifier encoded on an RIS-reflected beam.
Aspect 21: The method of any of Aspects 12-20, wherein the PBIT scheme is associated with virtual PBIT partitions.
Aspect 22: The method of any of Aspects 12-21, wherein the PBIT scheme is associated with an on-off keying scheme associated with only non-all-zero patterns.
Aspect 23: An apparatus for wireless communication at a device, comprising a processor; memory coupled with the processor; and instructions stored in the memory and executable by the processor to cause the apparatus to perform the method of one or more of Aspects 1-22.
Aspect 24: An apparatus for wireless communication at a device, comprising a processor; memory coupled with the processor, the memory storing instructions for the processor to cause the apparatus to perform the method of one or more of Aspects 1-22.
Aspect 25: A device for wireless communication, comprising a memory, and one or more processors coupled to the memory, the memory comprising instructions executable by the one or more processors to cause the device to perform the method of one or more of Aspects 1-22.
Aspect 26: A device for wireless communication, comprising a memory, and one or more processors coupled to the memory, the memory storing instructions for the one or more processors to cause the device to perform the method of one or more of Aspects 1-22.
Aspect 27: A device for wireless communication, comprising a memory and one or more processors coupled to the memory, the one or more processors configured to perform the method of one or more of Aspects 1-22.
Aspect 28: An apparatus for wireless communication, comprising at least one means for performing the method of one or more of Aspects 1-22.
Aspect 29: A non-transitory computer-readable medium storing code for wireless communication, the code comprising instructions executable by a processor to perform the method of one or more of Aspects 1-22.
Aspect 30: A non-transitory computer-readable medium storing code for wireless communication, the code comprising instructions for a processor to perform the method of one or more of Aspects 1-22.
Aspect 31: A non-transitory computer-readable medium storing a set of instructions for wireless communication, the set of instructions comprising one or more instructions that, when executed by one or more processors of a device, cause the device to perform the method of one or more of Aspects 1-22.
Aspect 32: A non-transitory computer-readable medium storing a set of instructions for wireless communication, the set of instructions comprising one or more instructions for one or more processors of a device to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A reconfigurable intelligent surface (RIS) for wireless communication, comprising:
memory; and
one or more processors coupled to the memory, the memory storing instructions for the one or more processors to cause the RIS to:
receive configuration information indicating a passive beamforming and information transfer (PBIT) scheme, the configuration information being based at least in part on at least one of energy consumption of the PBIT scheme or an error performance of the PBIT scheme; and
communicate information available to the RIS to the network device based at least in part on the PBIT scheme.

2. The RIS of claim 1, wherein the information available to the RIS includes data associated with the RIS.

3. The RIS of claim 2, wherein the data associated with the RIS includes at least one of:
sensor data associated with the RIS,
an indication of a maintenance status associated with the RIS,
an indication of a battery life associated with the RIS, or
an indication of whether the RIS is assisting an ongoing communication between network entities.

4. The RIS of claim 1, wherein the configuration information is based at least in part on an RIS controller associated with the RIS having a capability to receive communications from a network node and the RIS controller not having a capability to transmit communications to the network node.

5. The RIS of claim 1, wherein the configuration information is based at least in part on an RIS controller associated with the RIS having a capability to receive communications from a network node and the RIS controller having a capability to transmit communications to the network node.

6. The RIS of claim 1, wherein the information available to the RIS includes an indication that an RIS-reflected beam is reflected off of the RIS.

7. The RIS of claim 6, wherein the RIS-reflected beam is associated with a positioning reference signal.

8. The RIS of claim 6, wherein the RIS-reflected beam is associated with a sounding reference signal.

9. The RIS of claim 1, wherein the information available to the RIS includes an RIS identifier encoded on an RIS-reflected beam.

10. The RIS of claim 1, wherein the PBIT scheme is associated with virtual PBIT partitions.

11. The RIS of claim 1, wherein the PBIT scheme is associated with an on-off keying scheme associated with only non-all-zero patterns.

12. A network node for wireless communication, comprising:
memory; and
one or more processors coupled to the memory, the memory storing instructions for the one or more processors to cause the network node to:
select a passive beamforming and information transfer (PBIT) scheme that is to be used by a reconfigurable intelligent surface (RIS) to communicate information available to the RIS to a network device based at least in part on at least one of energy consumption of the PBIT scheme or an error performance of the PBIT scheme; and
transmit, to the RIS, configuration information indicating the PBIT scheme.

13. The network node of claim 12, wherein the information available to the RIS includes data associated with the RIS.

14. The network node of claim 13, wherein the data associated with the RIS includes at least one of:
sensor data associated with the RIS,
an indication of a maintenance status associated with the RIS,
an indication of a battery life associated with the RIS, or
an indication of whether the RIS is assisting an ongoing communication between network entities.

15. The network node of claim 12, wherein the memory stores instructions for the one or more processors to cause the network node to select the PBIT scheme based at least in part on an RIS controller associated with the RIS having a capability to receive communications from the network node and the RIS controller not having a capability to transmit communications to the network node.

16. The network node of claim 12, wherein the memory stores instructions for the one or more processors to cause the network node to select the PBIT scheme based at least in part on an RIS controller associated with the RIS having a capability to receive communications from the network node and the RIS controller having a capability to transmit communications to the network node.

17. The network node of claim 12, wherein the information available to the RIS includes an indication that an RIS-reflected beam is reflected off of the RIS.

18. The network node of claim 17, wherein the RIS-reflected beam is associated with a positioning reference signal.

19. The network node of claim 17, wherein the RIS-reflected beam is associated with a sounding reference signal.

20. The network node of claim 12, wherein the information available to the RIS includes an RIS identifier encoded on an RIS-reflected beam.

21. The network node of claim 12, wherein the PBIT scheme is associated with virtual PBIT partitions.

22. The network node of claim 12, wherein the PBIT scheme is associated with an on-off keying scheme associated with only non-all-zero patterns.

23. A method of wireless communication performed by a reconfigurable intelligent surface (RIS), comprising:
receiving configuration information indicating a passive beamforming and information transfer (PBIT) scheme, the configuration information being based at least in part on at least one of energy consumption of the PBIT scheme or an error performance of the PBIT scheme; and
communicating information available to the RIS to the network device based at least in part on the PBIT scheme.

24. The method of claim 23, wherein communicating the information available to the RIS to the network device based at least in part on the PBIT scheme includes communicating data associated with the RIS to the network device.

25. The method of claim 24, wherein communicating the data associated with the RIS to the network device includes communicating at least one of:
sensor data associated with the RIS,
an indication of a maintenance status associated with the RIS,
an indication of a battery life associated with the RIS, or
an indication of whether the RIS is assisting an ongoing communication between network entities.

26. The method of claim 23, wherein the PBIT scheme is associated with virtual PBIT partitions.

27. The method of claim 23, wherein the PBIT scheme is associated with an on-off keying scheme associated with only non-all-zero patterns.

28. A method of wireless communication performed by a network node, comprising:
selecting a passive beamforming and information transfer (PBIT) scheme that is to be used by a reconfigurable intelligent surface (RIS) to communicate information available to the RIS to a network device based at least in part on at least one of energy consumption of the PBIT scheme or an error performance of the PBIT scheme; and
transmitting, to the RIS, configuration information indicating the PBIT scheme.

29. The method of claim 28, wherein the PBIT scheme is associated with virtual PBIT partitions.

30. The method of claim 28, wherein the PBIT scheme is associated with an on-off keying scheme associated with only non-all-zero patterns.
